(19) United States
(12) Patent Application Publication
(10) Pub. No.: US 2005/0103554 A1
(43) Pub. Date: May 19, 2005

(54) Go-cart, kit for go-carts and apparatuses for controlling the run of a vehicle, for example a go-kart

(76) Inventor: Zeno Meglioli, Castellarano (IT)

Correspondence Address: NIXON & VANDERHYE, PC, 1100 N GLEBE ROAD, 8TH FLOOR, ARLINGTON, VA, 22201-4714, US

(21) Appl. No.: 10/509,091

(22) PCT Filed: Mar. 28, 2003
(86) PCT No.: PCT/IB03/01138

(30) Foreign Application Priority Data
Mar. 28, 2002 (IT) MO2002 A 000073

(51) Int. Cl. B60K 26/00

(52) U.S. Cl. 180/333

(57) ABSTRACT

An apparatus for controlling the run of a vehicle comprises a steering arrangement, suitable for directing said vehicle along a given trajectory, and a speed control device suitable for modifying the running speed of said vehicle, said speed control device comprising a first shaft slidably coupled with a second shaft and actuatable by said steering arrangement. A go-cart comprises a steering arrangement, suitable for directing said go-cart along a given trajectory, and a speed control device, suitable for modifying the running speed of said go-cart, said speed control device being so configured as to interact with said steering arrangement. An apparatus for controlling the run of a vehicle comprises a steering arrangement, suitable for directing said vehicle along a given trajectory, and a speed control device, suitable for modifying the running speed of said vehicle, said speed control device comprising articulated quadrilateral arrangement actuatable by said steering arrangement.

The invention concerns a vehicle such as a go-cart, i.e. a generally one-seater vehicle comprising an engine fitted to a chassis that is used for amusement or competitive purposes, and a kit for go-cart and apparatuses for controlling the run of a vehicle, for example a go-cart.

Go-carts are known that are provided with a steering wheel that is rigidly connected to a steering column, through which the driver can give the go-cart a preset trajectory and further comprising pedal controls for actuating the brake and the accelerator, by means of which the driver can regulate running conditions. To drive such go-carts the driver must simultaneously use his or her hands, which act on the steering wheel, and his or her feet, which act on the pedal controls.

One defect of known go-carts is that disabled persons, who are unable to use their lower limbs with agility, cannot drive existing go-carts and avail themselves of the amusement afforded by said go-carts.

Furthermore, the steering column of known go-carts is arranged obliquely to the surface of the ground on which the go-cart is driven and the steering wheel extends along a plane that is perpendicular to the longitudinal axis of the steering column. As a result, the steering wheel is arranged along a plane that is oblique in relation to the driver, who is thus forced to drive the go-cart while keeping his or her wrists bent in relation to his or her arms. This position is rather uncomfortable and furthermore it does not enable the effort exerted on the steering wheel to be precisely administered, thereby impairing, especially in the case of prolonged driving, the accuracy of the trajectory and, the stability of the vehicle.

A further defect of the known go-carts is that they are sometimes tiring to drive because excessive effort is needed to turn the steering wheel in order to set the desired trajectory. This is particularly serious for persons with limited strength in their arms such as certain types of handicapped person.

EP 0919422 discloses a vehicle provided with a steering wheel that can be moved towards and away from the driver's body to actuate an accelerating device or a braking device. The steering wheel is fixed to one end of a column that can rotate in relation to a fixed support to enable the driver to steer the vehicle and can translate in relation to said support to interact with the acceleration or braking device.

One defect of the apparatus for controlling the run of the vehicle disclosed in EP 0919422 is that it cannot be fitted to already existing motor vehicles to make them suitable for being driven by persons unable to control their lower limbs. In other words, the apparatus disclosed in EP 0919422 does not enable an ordinary vehicle provided with pedals to actuate the brake and accelerator to be converted into a motor vehicle the direction and speed of which can be controlled completely manually.

Furthermore, as the column that supports the steering wheel can both rotate and translate in relation to a single support a distracted or inexpert driver who wishes to brake or accelerate may accidentally turn the steering wheel. In this case the vehicle is steered in an undesired manner, which diminishes running safety and may lead to dangerous accidents.

One aim of the invention is to improve existing go-carts.

A further aim of the invention is to make existing go-carts suitable for being driven in a relatively easy manner also by disabled persons who are unable to use their lower limbs.

Yet another further aim of the invention is to make the driving position more comfortable for the driver, especially as far as gripping and handling the steering wheel is concerned.

Another aim of the invention is to decrease the effort required to rotate the steering wheel of the go-carts.

Another further aim of the invention is to enable an ordinary motor vehicle to be transformed into a motor vehicle the speed of which can be controlled manually in such a way as to make it suitable for being driven by disabled persons or beginners who are incapable of precisely coordinating the actions of hands and feet.

Yet another further aim is to provide a vehicle the direction and speed of which can be controlled manually, and wherein the risks of accidentally turning the steering wheel when one wishes only to brake or accelerate are reduced.

According to a first aspect of the invention, a go-cart is provided, comprising steering means, suitable for directing said go-cart along a given trajectory, and speed control means, suitable for modifying the running speed of said go-cart, characterised in that, said speed control means is so configured as to interact with said steering means.

This aspect of the invention enables disabled persons, especially persons who are unable to use their lower limbs with agility, to drive easily even go-carts because they can use the steering means to also adjust the speed control means. The same parts of the body, e.g. the hands, that by means of the steering means set the trajectory of the go-cart can therefore also actuate the speed control means, eliminating the necessity to use different parts of the body, e.g. the feet, to control the speed of the vehicle.

According to a second aspect of the invention, a go-cart is provided, said go-cart being provided with steering means comprising steering column means and steering wheel means by means of which a driver can set a trajectory for said go-cart, characterised in that, between said steering wheel means and said steering column means joint means is placed, said joint means being suitable for enabling said steering wheel means to be positioned according to a tilt that is substantially independent of said steering column means.

The joint means enables the steering wheel means to be provided with a tilt that is different from that of the steering column means in such a way as to give the steering wheel means a tilt that is comfortable for the driver, e.g. by arranging it on a plane that is almost parallel to the driver's chest. The driving position is thus significantly more comfortable and enables the driver to drive the go-cart even for very long periods without feeling discomfort in the arms or wrists.

According to a third aspect of the invention, a kit for a vehicle is provided, comprising braking control means suitable for actuating braking means of said vehicle, and acceleration control means suitable for actuating acceleration means of said vehicle, said braking control means and said acceleration control means being so configurable as to interact with steering means of said vehicle.

This aspect of the invention enables a traditional vehicle such as a go-cart to be modified by equipping it with braking control means and acceleration control means that can interact with the steering means of the go-cart. By so doing, by intervening on the steering means the driver can modify the vehicle speed according to vehicle running requirements without having to use parts of the body other than those that act on the steering means. This is of great use for disabled persons, who, owing to this aspect of the invention, can convert a vehicle of traditional type, which they would not be capable of driving, into a modified vehicle that they can drive by using for example only their hands. There is no need to emphasise that the kit according to this aspect of the invention enables considerable savings to be made compared with the expense required to construct a new vehicle suitable for disabled persons, for example a go-cart.

According to a fourth aspect of the invention, an apparatus for controlling the run of a vehicle is provided comprising steering means provided with first steering column means slidable in relation to second steering column means in order to modify the speed of said vehicle, and further comprising position sensor means suitable for detecting the axial position of said first steering column means in relation to said second steering column means.

The position sensor means enables the axial position of the first steering column means to be accurately detected in relation to the second steering column means in such a way as to be able to associate in an extremely precise manner a preset acceleration or braking intensity with each position of the first steering column means. It is thus possible to obtain a vehicle that can be controlled in an extremely precise and reliable manner using only the hands.

According to a fifth aspect of the invention, a go-cart is provided comprising steering means through which a driver can set a trajectory of said go-cart, said steering means comprising control means arranged for modifying the position of wheels of said go-cart according to a command of said driver, characterised in that, said control means comprises hydraulic drive means arranged for hydraulically modifying said position.

The hydraulic drive means enables the trajectory of the go-cart to be set in a particularly easy manner and without exerting excessive effort. Thus, even persons with little strength in their arms such as handicapped persons can drive the go-cart.

According to a sixth aspect of the invention, an apparatus for controlling the run of a vehicle is provided, comprising steering means suitable for enabling said vehicle to be directed along a given trajectory, and speed control means, suitable for modifying the running speed of said vehicle, characterised in that, said speed control means comprises articulated quadrilateral means actuatable by said steering means.

The articulated quadrilateral means provides a constraint for the movement of the steering means when the latter is used to actuate the speed control means. The involuntary movements of the steering means are thus avoided, which could cause involuntary modifications to the trajectory whilst the driver is braking or accelerating.

Furthermore, the articulated quadrilateral means enables the speed control means to be actuated in a particularly effective and reliable manner.

According to a seventh aspect of the invention, an apparatus for controlling the run of a vehicle is provided, comprising steering means, suitable for allowing said vehicle to be directed along a given trajectory, and speed control means, suitable for modifying the running speed of said vehicle, characterised in that, said speed control means comprises first shaft means slidably coupled with second shaft means and actuatable by means of said steering means.

Owing to the slidable coupling between the first shaft means and the second shaft means, it is possible to transform the traditional vehicles, provided with pedal-operated acceleration or braking means, in vehicles wherein the speed can be controlled by the steering means. To do so, it is sufficient to slidably couple the second shaft means with which an ordinary vehicle is equipped with an appropriately preset first shaft means.

The invention will be better understood and carried out with reference to the attached drawings, which illustrate some exemplifying and not restrictive embodiments thereof, wherein:

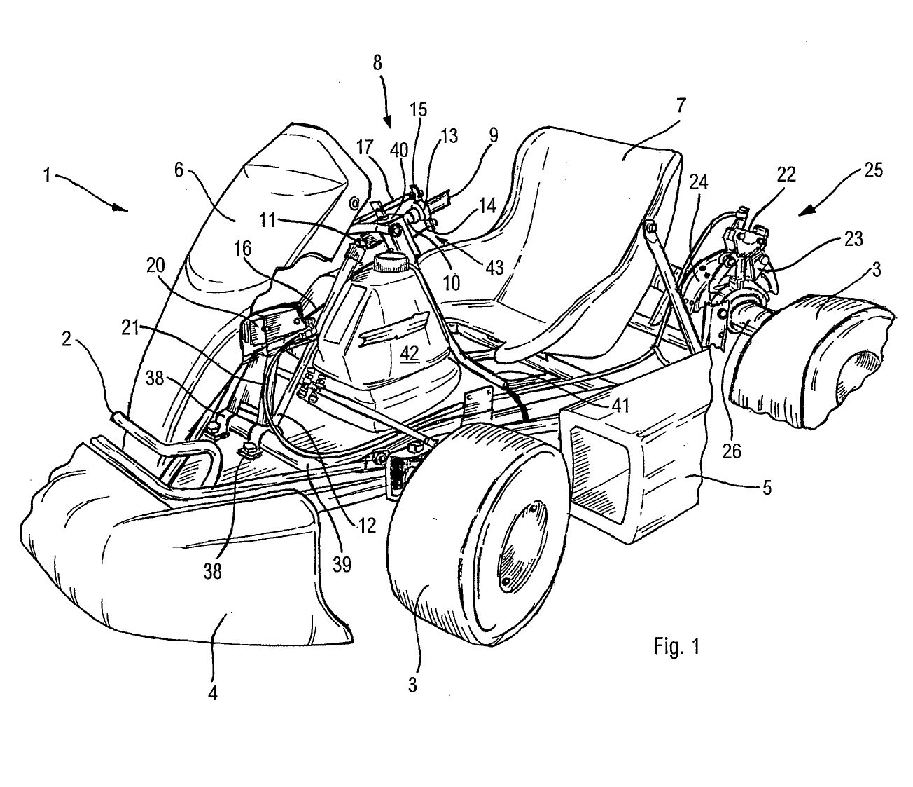

FIG. 1 is an interrupted perspective view of a go-cart according to the invention;

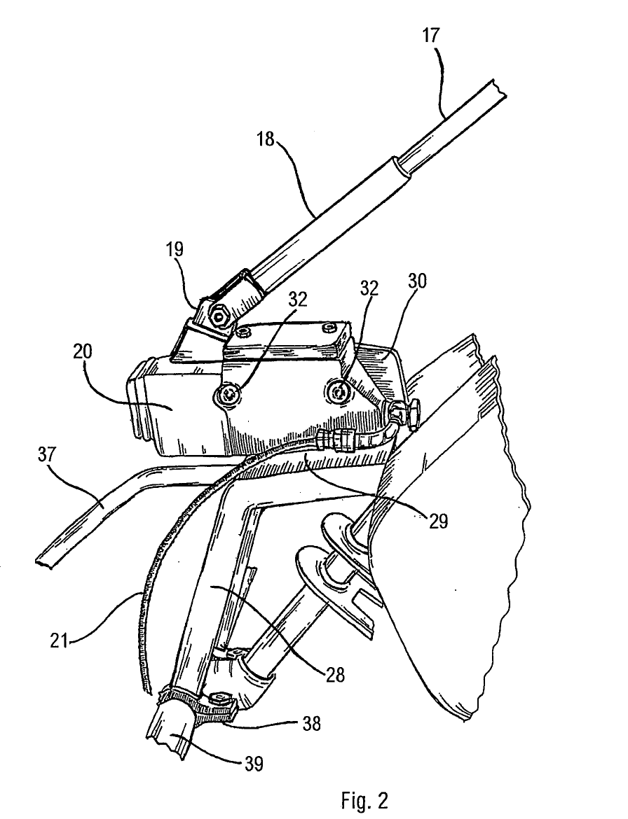

FIG. 2 is an enlarged and interrupted perspective view of braking means with which the go-cart of FIG. 1 is provided;

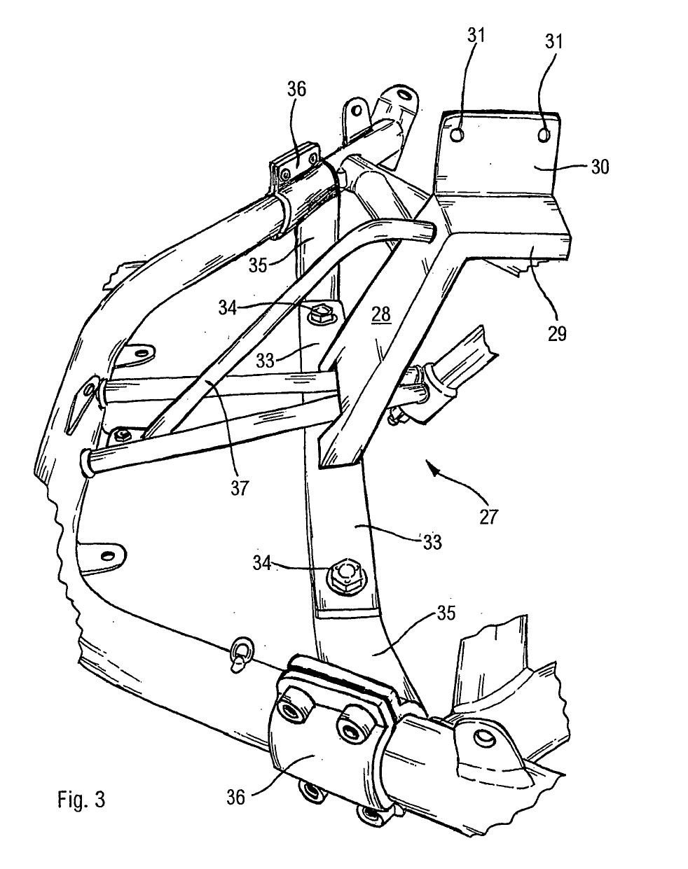

FIG. 3 is an enlarged and interrupted perspective view of support means of the braking means of FIG. 2;

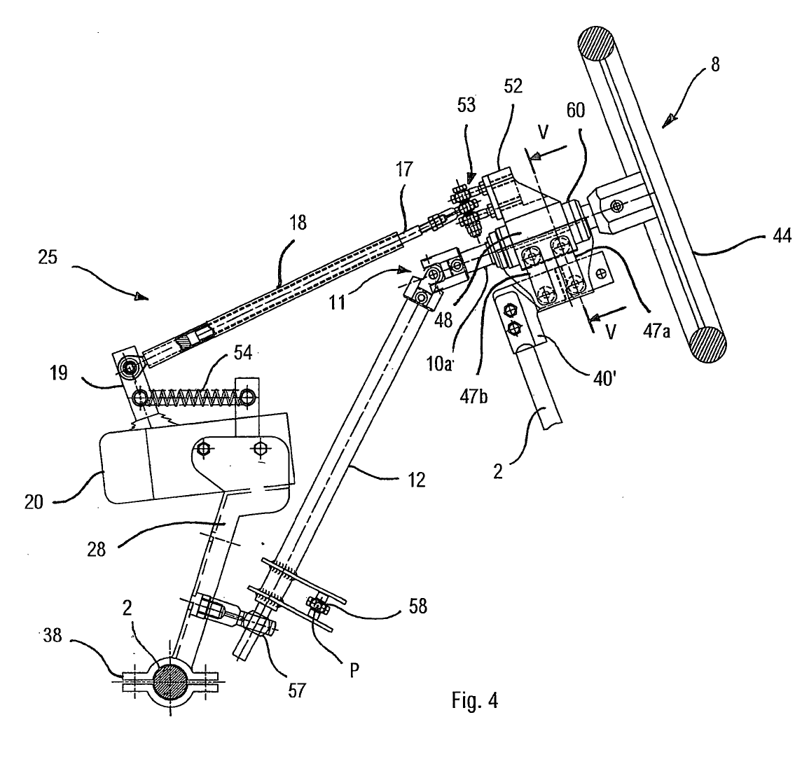

FIG. 4 is an interrupted side view of steering means associated with speed control means, in an alternative embodiment;

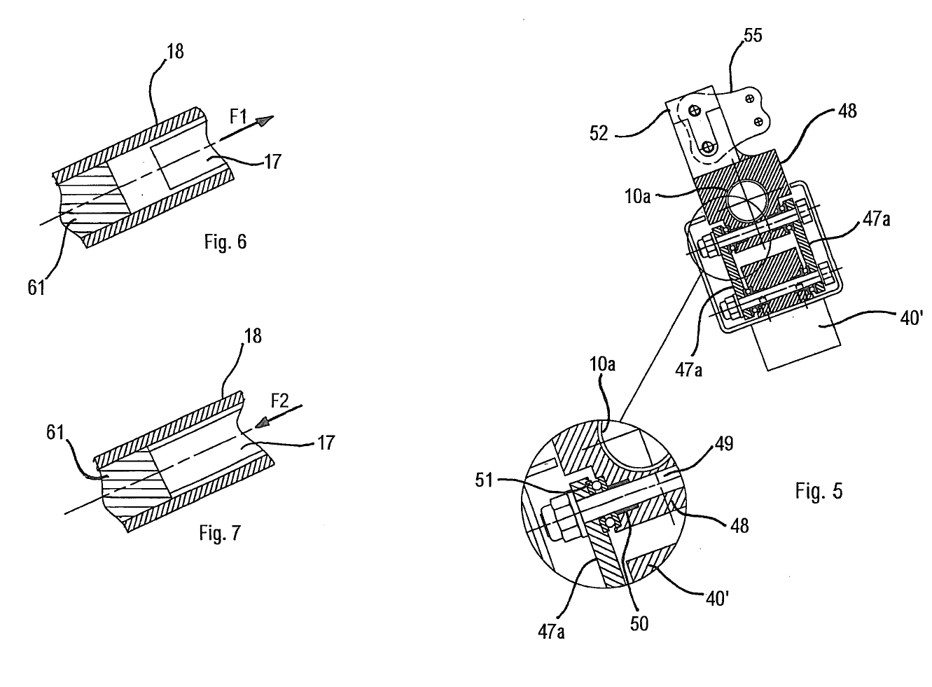

FIG. 5 is an enlarged section taken along the plane V-V of FIG. 4;

FIGS. 6 and 7 show an enlarged detail of the braking means, in two differing operating configurations;

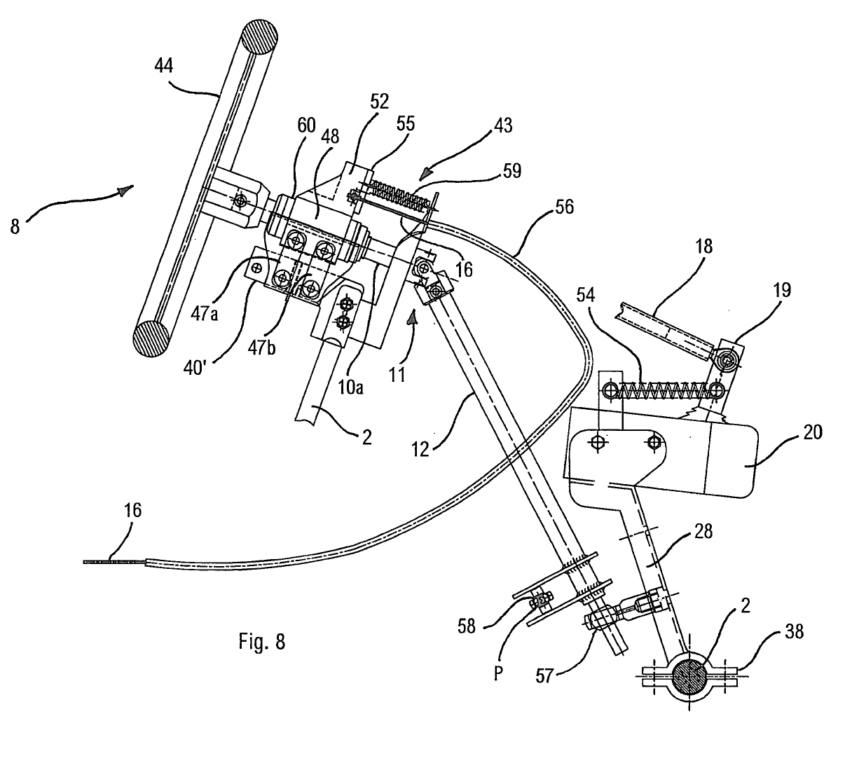

FIG. 8 is a view like the one in FIG. 4, showing acceleration means with which the go-cart is provided,

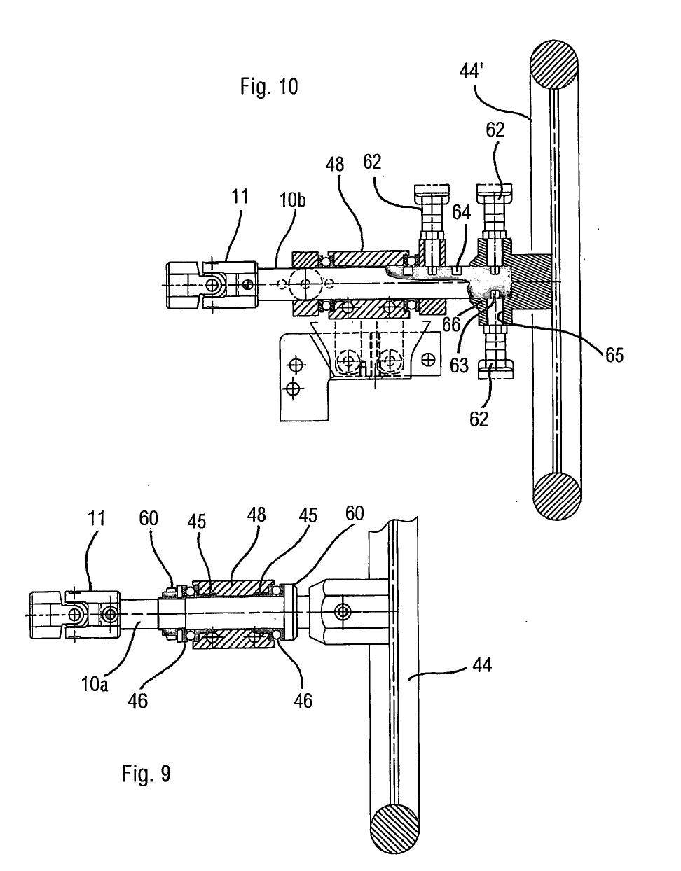

FIG. 9 is a partially sectioned and interrupted view of the steering means of FIG. 4;

FIG. 10 is a partially sectioned and interrupted view of steering means provided with a removable steering wheel;

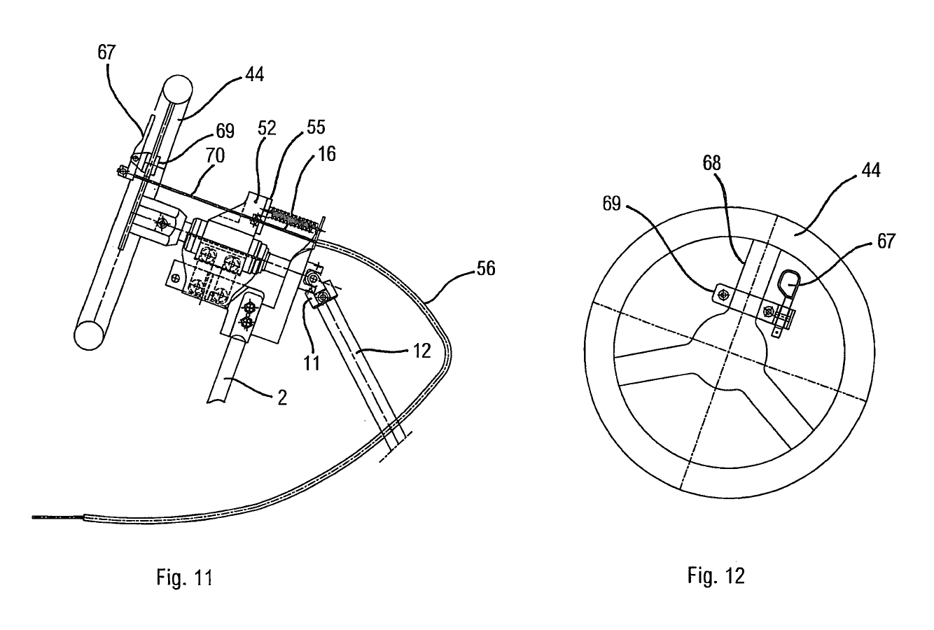

FIG. 11 is an interrupted side view of steering means provided with lever means arranged for actuating speed control means in particular operating conditions;

FIG. 12 is a front view of a steering wheel provided with the lever means of FIG. 11;

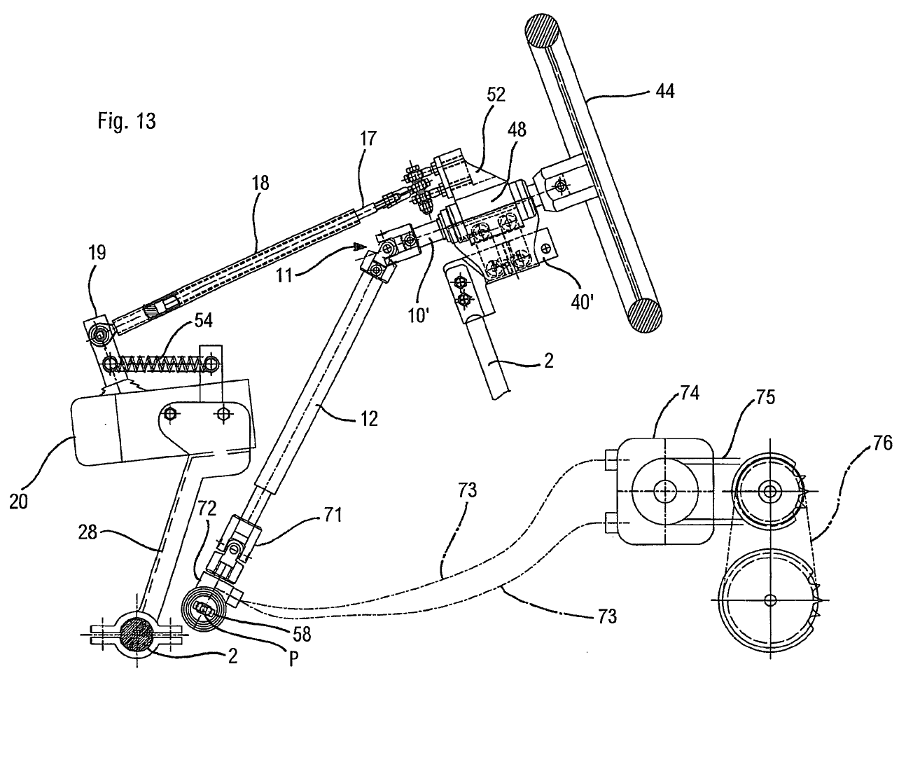

FIG. 13 is a diagrammatic and interrupted side view of a go-cart provided with a hydraulic drive system;

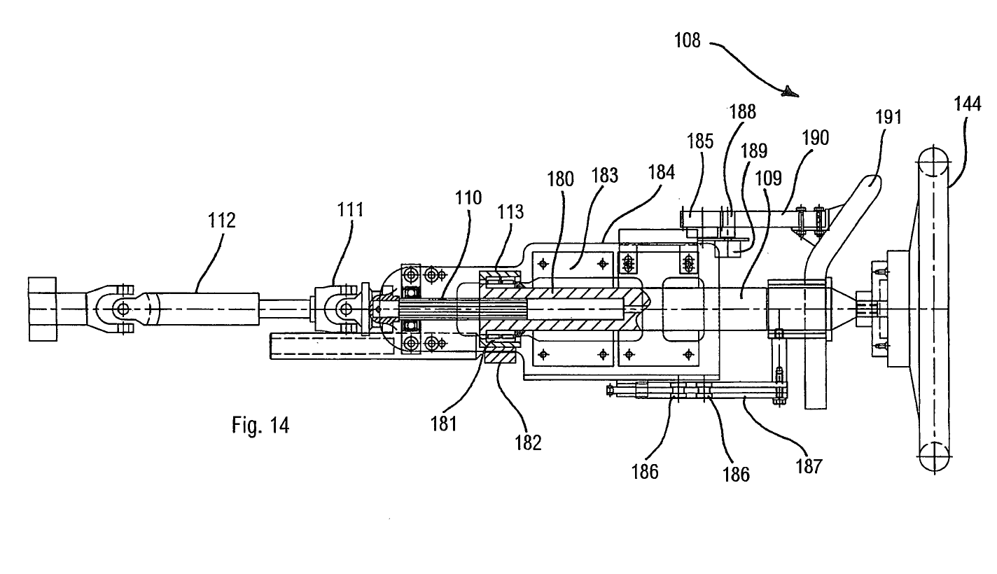

FIG. 14 is an interrupted and partially sectioned view from above of the steering means of a motor vehicle;

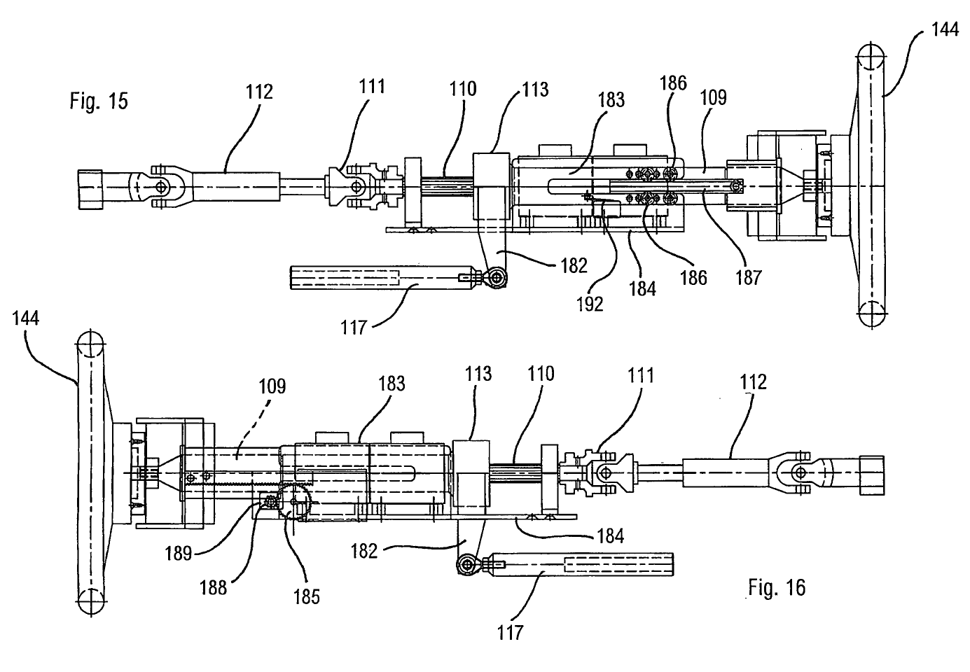

FIG. 15 is a side view from the left of the steering means of FIG. 14;

FIG. 16 is a side view from the right of the steering means of FIG. 14;

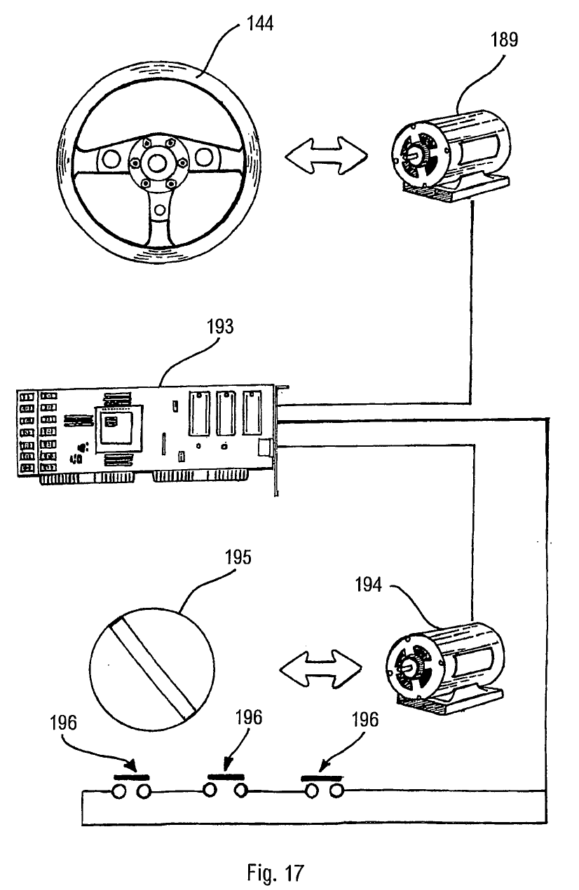

FIG. 17 shows an electric diagram of acceleration means suitable for being fitted to a motor vehicle.

FIG. 1 shows a go-cart 1 comprising a chassis 2 on which wheels 3 are rotationally supported, said wheels 3 being arranged for allowing the go-cart 1 to move along a road, track or any other route. On the chassis 2 a front bumper 4, two side bumpers 5 and a guard 6 are fitted that are suitable for protecting the chassis 2 and other mechanical parts connected to it in the event of the go-cart 1 knocking into other go-carts or obstacles placed along the track.

A seat 7, which is also supported on the chassis 2, enables a driver to be accommodated who controls the go-cart 1 by using steering means 8 that is provided with a steering wheel that is not shown. The steering means 8 further comprises a sleeve 9, that is connected as one with the steering wheel, the sleeve 9 being axially slidable in relation to a shaft 10. A prismatic joint, that is not shown, comprising for example a grooved surface made inside the sleeve 9 suitable for shapingly coupling with a further grooved surface made on the shaft 10 enables the sleeve 9 to translate along the shaft 10 whilst preventing relative rotation.

The shaft 10 is coupled by a joint 11, e.g. a cardan joint, to a steering column 12. The variation in the angular position of the steering column 12, due to rotation of the steering wheel, enables the position of the wheels 3 to be varied to modify the trajectory of the go-cart 1 using prior-art kinematics.

The joint 11 enables the tilt of the shaft 10 and therefore of the steering wheel to be modified in relation to the steering column 12 in such a way that the shaft 10 is in a position that is almost parallel to the ground on which the go-cart 1 is driven. Thus, the steering wheel, which lies on a plane that is substantially perpendicular to the longitudinal axis of the shaft 10, is almost parallel to the driver's chest. The driving position of the go-cart 1 is thus considerably more comfortable than that of the prior-art go-carts wherein the lack of joint 11 means that the steering wheel is perpendicular to the steering column 12 and forces the driver into an uncomfortable and unnatural position for his hands.

A ring 13 is fixed rigidly to the sleeve 9, which ring is provided with a first appendage 14 and a second appendage 15 and enables speed control means to be actuated, said speed control means comprising braking means 25 and acceleration means 43. The acceleration means 43 comprises a cable 16, connected at a first end thereof to the first appendage 14, and at a second end thereof to a valve, e.g. a throttle valve, which enables the mixture formed in a carburettor that is not shown to enter the engine actuating the go-cart 1.

To the second appendage 15 an actuating rod 17 is connected that is arranged to actuate the braking means 25, as shown in greater detail in FIG. 2.

The actuating rod 17 is slidably engaged, near its end that is furthest from the second appendage 15, in an internally hollow stem 18 hinged on a lever 19 in a terminal area of the stem 18 opposite the actuating rod 17. The lever 19 may oscillate around an intermediate point thereof and is partially housed in the containing body of a pump 20 that is part of the braking means 25, so that the end of the lever 19 furthest from the stem 18 may actuate piston means that is not shown that is contained inside the pump 20. The latter sends a pressurised fluid, e.g. oil, into a brake circuit comprising a flexible conduit 21 that by means of a caliper 22 actuates two shoes 23 working with a disk 24 positioned on the motor axis 26 of the go-cart 1. Thus it is possible to make the drive wheels of the go-cart 1 brake, namely the rear wheels.

The pump 20 is fitted to the go-cart 1 by means of support means 27, shown in detail in FIG. 3, comprising a bracket 28 provided with a horizontal support plane 29 from which an anchor wall 30 develops that is provided with two fixing holes 31. The pump 20 is positioned on the support plane 29 and is then pressed against the anchor wall 30 and fixed thereto by bolts 32 that engage in the holes 31.

The support plane 29 ensures that the pump 20 is maintained in a horizontal position during running, which makes it very difficult to absorb air bubbles within the pressurised fluid, which bubbles, being compressible, could diminish the effectiveness of the braking means.

The bracket 28 is provided at the bottom with two lateral diametrically opposed extensions 33 that may be fixed by further bolts 34 to two arms 35 fixed to the chassis 2 by means of clamps 36.

In an alternative embodiment, shown in FIGS. 1 and 2, instead of two lateral extensions 33, the bracket 28 can be provided at the bottom with two further clamps 38 that are fixed to a transversal bar 39, with which certain chassis types are provided.

To ensure that the pump 20 is kept in a position as stable as possible despite the vibrations that develop during the run of the go-cart 1 a stiffening element 37 is further provided that connects the top part of the bracket 28 to a front area of the chassis 2 so as to increase the bending and torsional stiffness of the bracket 28.

The go-cart 1 further comprises a support element 40 arranged to support the shaft 10, the support element 40 being fixed to the members 41 that bear the tank 42 of the go-cart 1.

To adjust the speed of the go-cart 1, the driver has to act on the steering wheel, pulling it towards or pushing it away from him or herself so as to cause it to translate in relation to the shaft 10. In particular, when the driver decides to accelerate he or she has to pull the steering wheel towards him or herself in such a way that the sleeve 9 translates in relation to the shaft 10 and the ring 13 together with the two appendages 14 and 15 fixed thereto shifts towards the driver's body. Thus, traction is exerted on the cable 16 that causes the valve of the carburettor to open, which valve lets the mixture formed in the carburettor pass through towards the engine cylinders. The go-cart 1 is thus accelerated.

Near the carburettor a spring is further provided that takes the cable 16 to a rest position when the driver stops accelerating, i.e. stops pulling the steering wheel towards him or herself.

It should be noted that when the driver pulls the steering wheel towards him or herself this does not have any effect on the braking system because the shift of the ring 13 and of the two appendages 14 and 15 connected to it causes the actuating rod 17 to slide inside the stem 18 without having any effect on the lever 19 and therefore on the pump 20 that supplies the fluid into the brake circuit.

If, on the other hand the driver wishes to brake he or she must push the steering wheel away from him or herself in such a way that under the thrust of the second appendage 15 of the ring 13 the actuating rod 17 penetrates into the stem 18 until it causes the lever 19 to oscillate around its fulcrum. The lever 19 thus actuates the piston means of the pump 20 that supplies the fluid inside the flexible conduit 21, thereby tightening the caliper 22 and then the shoes 23 on the disk 24 of the braking means 25.

When the driver pushes the steering wheel away from him or herself to brake this does not have any effect on the acceleration means: by pushing the cable 16 the latter bends without modifying the configuration of the carburettor. The braking and accelerating actions are thus totally independent of each other.

In addition to building a new go-cart 1 that is configured according to the above description, it is also possible to convert a traditional go-cart to enable it operate in the manner explained previously. To do this it is sufficient to remove the steering wheel from the traditional go-cart, if necessary shorten the steering column 12 and fit an appropriate adaptation kit on the traditional go-cart. This kit comprises the joint 11, which is fitted to the steering column 12 that may have been shortened, the shaft 10 and the sleeve 9, which is connected to the steering wheel. The shaft 10 is advantageously provided with the ring 13 and the two appendages 14 and 15 supporting the cable 16 and the actuating rod 17. The shaft 10 must furthermore be supported on the chassis 2 by means of an appropriate support element 40 that is part of the adaptation kit, and support means 27 of the pump 20 in relation to the chassis 2 must be provided. The above mentioned kit thus makes it possible, with a small number of simple operations, to pass from a go-cart wherein the brake and the accelerator are actuated by pedals to a go-cart the controls of which are completely manual.

In an alternative embodiment, shown in FIG. 4, a go-cart is provided that is equipped with a steering wheel 44 to which the shaft 10a is fixed, which shaft is in turn connected to the steering column 12 by means of the joint 11. As shown in FIG. 9, the shaft 10a is received for a portion of its length inside a movable member 48. Between the shaft 10 and the movable member 48 radial bearings 45 are placed owing to which the shaft 10a can rotate in relation to the movable member 48 when the driver turns the steering wheel 44 to point the go-cart in a given direction. Axial bearings 46 are further provided that are placed between the movable member 48 and respective stop elements 60, the stop elements 60 being fixed to the shaft 10a to prevent relative translation of the movable member 48 and of the shaft 10a.

The movable member 48 is connected to the chassis 2 by articulated quadrilateral means. In the embodiment in FIG. 4, the articulated quadrilateral means comprises articulated parallelogram means provided with two pairs of rocker arms 47a, 47b hinged near respective first ends, on the movable member 48 inside which the shaft 10a is housed as shown in detail in FIG. 5. The second ends of the rocker arms 47a, 47b are hinged on a fixed support element 40′ that is connected with the chassis 2. As shown in FIG. 5, the two pairs of rocker arms 47a, 47b are arranged on opposite sides of the movable member 48 and of the fixed support element 40′ in such a way that the movable member 48 is guided on both sides during its movement in relation to the chassis 2.

As shown in the enlarged detail in FIG. 5, each end of the two rocker arms 47a, 47b is hinged on the movable member 48 or on the fixed support element 40′ by means of respective pins 49, rotationally supported by means of respective further radial bearings 50. Further axial bearings 51 are further provided that enable the pins 49 and therefore the rocker arms 47a, 47b to oscillate in relation to the movable member 48 and/or the fixed support element 40′ even if forces directed along the axis of the pins 49 are applied.

A L-shaped element 52 is fixed to an upper portion of the movable member 48, the L-shaped element 52 being in turn fixed to the braking means 25 and to the acceleration means 43. In particular, the actuating rod 17 of the braking means 25 is fixed to the L-shaped element 52 with ball joint means 53 placed inbetween. Said rod is slidable inside the stem 18 to actuate the pump 20 in the manner already described with reference to FIG. 2.

It is to be noted that in the embodiment in FIG. 4 a return spring 54 is further provided that is arranged to return the lever 19 to its rest position when the driver of the go-cart does not perform any braking action.

As shown in FIGS. 5 and 8, a plate 55 is also fixed to the L-shaped element 52 on which plate 55 an end of the cable 16 is locked, said cable 16 being sheathed along most of its route in a protective sheath 56 and actuating the throttle valve of a carburettor that is not shown.

When the driver pulls towards himself or herself or pushes away from himself or herself the steering wheel 44 the articulated parallelogram means limits the movement of shaft 10a in relation to the chassis 2. The two pairs of rocker arms 47a, 47b in fact limit the movable member 48 to travelling along a route according to which the axis of the shaft 10a always remains contained in the same vertical plane.

Said route is not completely straight but the resulting deviations therefrom can be compensated by the degrees of freedom introduced by the parts of the joint 11, by the articulated joint 57 arranged between the steering column 12 and the chassis 2 and by the further articulated joint 58 placed between the steering column 12 and the connection point P of the tie rods that make the wheels steering. In particular, the articulated joint 57 and the further articulated joint 58 enable the end of the steering column 12 furthest from the shaft 10a to be lifted and lowered in relation to the chassis 2 when the steering wheel 44 is moved axially without impairing correct operation of the steering device connected to the steering column 12.

Apart from these differences, the operation of the embodiment shown in FIGS. 4 to 8 has many similarities to that of the embodiment shown in FIGS. 1 to 3.

In particular, when the driver draws the steering wheel 44 towards himself or herself the steering wheel 44 exerts traction on the cable 16, which opens the throttle valve of the carburetter. The vehicle is thereby accelerated. The braking means 25 remains inactive during this phase because, as shown by the arrow F1 in FIG. 6, the actuating rod 17 is displaced inside the stem 18 in such a way as to move away from an abutting element 61 that is fixed to said stem, which remains in a fixed position. Consequently, the lever 19 remains in its rest position.

On the other hand, when the driver pushes the steering wheel 44 away from his or her body, the actuating rod 17 is displaced inside the stem 18 in the direction of the arrow F2 in FIG. 7, until it abuts against the abutting element 61. Continuing to push the steering wheel makes the actuating rod 17 move the stem 18 and the lever 19 with it, which actuates the pump 20. Fluid is then sent under pressure into the brake circuit and the vehicle brakes.

The acceleration means 43 is not actuated during this phase because after pressure has been exerted on the steering wheel 44 the cable 16 is bent back on itself without performing any action on the carburetter. A further spring 59 makes the cable 16 return, which takes the throttle valve back to its equilibrium position.

Also in the case of the embodiment shown in FIGS. 4 to 9 an adaptation kit can be set up by means of which a traditional go-cart can be transformed into a go-cart suitable for being driven without the driver's using his or her legs.

Furthermore, the actuation modes for the braking and acceleration means shown in FIGS. 4 to 9 and in particular the articulated parallelogram means can be used not only in a go-cart but also in a different type of motor vehicle such as an automobile.

In the embodiment disclosed in FIGS. 11 and 12 the steering wheel 44 is provided with manual actuating means for actuating the acceleration means 43, comprising a further lever 67. By acting on the further lever 67 the driver may exert traction on the cable 16. The further lever 67 is pivoted in a central portion thereof on a clamp element 69 fitted to a rung 68 of the steering wheel 44. The further lever 67 is provided with a broadened end on which the driver can act, for example, by using his thumb and with a further end to which an extension 70 of the cable 16 is connected, said extension 70 coming from the plate 55.

By pushing the broadened end of the further lever 67 towards the steering column 12, the further lever 67 oscillates around the respective fulcrum and the further end connected to the cable 16 rises towards the driver's body. Thus the cable 16 is placed under traction so as to open the throttle valve of the carburetter and accelerate the go-cart, without, however, moving the steering wheel 44 axially.

Owing to the manual actuating means, the driver can keep the go-cart stationary by pushing the steering wheel 44 away from his or her body in such a way as to activate the braking means 25 and at the same time accelerate the go-cart by means of the further lever 67. When the go-cart has accelerated completely, the driver can pull the steering wheel 44 towards himself or herself to release the braking means 25. As the engine is at this moment supplying all or a large part of its power, the driver can therefore obtain a particularly aggressive and competitive start for the go-cart.

FIG. 10 shows a steering wheel 44′ arranged to be attached to and detached from a shaft 10b connected to the steering column 12 by means of the joint 11. For this purpose quick connectors 62 are provided that are equipped with respective protruding parts 63 suitable for shapingly coupling with seats 64 made on the shaft 10b. The quick connectors 62 are inserted inside holes 65 made on a tubular end 66 that is one with the steering wheel 44′, within which the shaft 10b is accommodated.

By means of very simple movements such as pressure or traction that may be accompanied by rotation, the quick connectors 62 can be removed from the seats 64 and enable the steering wheel 44′ to be detached from the shaft 10b. This allows a disabled person with limited motor capacity to remove the steering wheel 44′ in order to more easily access the driving seat or to alight from the vehicle more easily. When the driver is in the driving position the steering wheel 44′ can be again fixed to the shaft 10b by inserting the quick connectors 62 into the holes 65 and then into their respective seats 64.

It should be noted that the driver who alights from the vehicle can also take with him or her the steering wheel 44′ that was removed from the shaft lob, in which case the steering wheel 44′ also acts as an antitheft device. In fact, the theft of a vehicle without a steering wheel is significantly more complicated than the theft of a vehicle provided with a steering wheel.

In the embodiment in FIG. 10, the movable member 48 and the braking and acceleration means described previously are associated with the shaft 10b; it is nevertheless possible to also envisage a steering wheel that can be moved in the manner described above also in a vehicle wherein the braking and accelerations means are actuated by a pedal system.

The movable steering wheel can also be provided not only for a go-cart but also for another type of vehicle.

FIG. 13 shows a go-cart provided with a hydraulic drive system. In the embodiment in FIG. 13, the end of the steering column 12 furthest from the steering wheel 44 is associated with a known hydraulic drive box 72 with a further joint 71 placed inbetween.

Said box controls, according to known operating principles, steering of the wheels of the go-cart, by means of steering tie rods that are not shown that are connected to the further articulated joint 58 at point P as previously described.

Two pipes 73 come out of the hydraulic drive box 72, which pipes 73 are in turn connected to the delivery and intake ports of a further pump 74. The latter is actuated by belt means 75, moved by chain means 76 that is driven by the driving shaft of the go-cart.

In a further embodiment, the steering wheel is connected to a first steering column that is axially slidable in relation to a second steering column. For example, the first steering column may be hollow in such a way that the second steering column can slide inside the first steering column. Similarly to what has been described previously, the driver can regulate the speed by pulling towards or pushing away from him or herself the steering wheel, but with a different actuating mechanism for the brakes or accelerator from what has been described above. Position sensor means is in fact provided that enables the position of the first steering column to be detected, i.e. the position of the slidable steering column, in relation to the second fixed steering column.

The position sensor means is connected with processing card means that processes the signal received from the sensor means and, depending on the position that the first steering column occupies in relation to the second steering column, actuates with a certain intensity the braking means or the acceleration means.

The position sensor means may comprise an encoder, the shaft of which is connected with a gear wheel cooperating with a rack fixed to the first steering column. Thus, when the driver modifies the axial position of the first steering column, and of the rack with it, the gear wheel is rotated and the change in its angle position is detected by the encoder, which transmits it to the processing card.

In a yet further embodiment the position sensor means may comprise means for reading an optical or magnetic band that is fixed to the first steering column means or to the second steering column means.

FIGS. 14, 15 and 16 illustrate an embodiment wherein the acceleration means comprises a position sensor 189, e.g. a potentiometer or an encoder. Said Figures show steering means 108 of a motor vehicle comprising a steering wheel 144 fixed to a first shaft 109 provided with a tubular end portion 180 that is slidable in relation to a second shaft 110. The latter is in turn connected, by means of a joint 111, to a steering column 112 arranged to direct the wheels in the required direction owing to a known steering device. The second shaft 110 is externally provided with a grooved surface that is suitable for shapingly coupling with a further grooved surface made inside the tubular end portion 180 of the first shaft 109. This enables the first shaft 109 to translate in relation to the second shaft 110, at the same time preventing the relative rotation.

The first shaft 109 is rotationally supported on a ring member 113, by means of bearings 181 placed inbetween. The ring member 113 is furthermore configured in such a way that it can be translated as one with the first shaft 109. An appendage 182 is fixed to the ring member 113, on said appendage 182 the first end of an actuating rod 117 being hinged. The actuating rod 117 is arranged for actuating a braking device in the manner previously disclosed with reference to FIGS. 1, 2 and 4.

The first shaft 109 is fitted inside a fixed hollow element 183 connected to a support plate 184. On one side of the fixed hollow element 183 guide wheels 186 are fitted between which a bar 187 may slide, the bar 187 being one with the steering wheel 144.

On the side of the fixed hollow element 183 opposite the one that supports the guide wheels 186 a gear wheel 185 is fitted, the gear wheel 185 engaging with a sprocket 188 on the axis of which a position sensor 189 is fitted. The toothed gear 185 is driven by means of a rack 190 fixed to a protruding element 191 that is in turn connected to the first shaft 109.

A microswitch 192 is further fixed to the fixed hollow element 183, the closure or opening of the microswitch 192 being associated with a reference position of the acceleration means.

When the driver of the motor vehicle exerts steering action on the steering wheel 144, the latter rotates the first shaft 109 in relation to the fixed hollow element 183 and the ring member 113. The first shaft 109, owing to the coupling with grooved surfaces, in turn rotates the second shaft 110, which actuates, by means of the joint 111, the steering column 112 that controls wheel steering.

When the driver wishes to brake, he or she must push the steering wheel 144 away from his or her body, which steering wheel 144 translates as one with the first shaft 109, the ring member 113 and the appendage 182 fixed to it. The actuating rod 117 is then moved in such a way as to activate the pump of the braking means that pressurises a fluid arranged for tightening the shoes of the caliper of the brakes on a disk fitted to the driving axis in such a way as to decrease the speed of the vehicle.

On the other hand, when the driver wishes to accelerate he must pull towards himself the steering wheel 144, which moves as one with the rack 190, which rack 190 actuates the gear wheel 185 engaging with the sprocket 188. The position sensor 189 sends an electric signal corresponding to the position of the sprocket 188 to the data card 193, shown in FIG. 17, and this signal is used to actuate an electric motor 194, e.g. a step motor, that modifies the position of the throttle valve 195 of a carburetter. In particular, the throttle valve 195 is opened by an amount that corresponds to the position of the sprocket 188 and therefore of the rack 190, which enables the driver of the motor vehicle to regulate the degree of acceleration according to factors such as traffic conditions, type of road being travelled on, road surface situation and so on.

The motor vehicle can furthermore be provided with safety sensors 196 that are for example provided on the front or back bumper to stop any acceleration commanded by the driver in cases wherein said sensors detect an obstacle arranged in their vicinity.

Finally, a vehicle provided with speed control means such as the one described in the previous Figures may also be provided with automatic or sequential speed gear.

The device in FIGS. 14, 15 and 16 can be provided in any motor vehicle in order to provide a system for controlling the direction and speed of the entire vehicle by means of the sole hands, which as such is particularly suitable for use by persons who are unable to use their legs.

In particular, the device in FIGS. 14, 15 and 16 can be used in a motor vehicle or a go-cart.

It should be noted that it is also possible to provide speed control means that does not comprise a steering wheel that is axially movable in relation to the steering column, but wherein the driver can manually activate braking means or acceleration means without shifting the steering wheel, e.g. by means of control switches.

1-126. (canceled)

127. Apparatus for controlling the run of a vehicle, comprising a steering arrangement, suitable for allowing said vehicle to be directed along a given trajectory, and a speed control arrangement, suitable for modifying the running speed of said vehicle, wherein said speed control device comprises a first shaft slidably coupled with a second shaft and actuatable by means of said steering arrangement.

128. Apparatus according to claim 127, wherein said first shaft is telescopically coupled with said second shaft.

129. Apparatus according to claim 127, wherein any relative rotation between said first shaft and said second shaft is substantially prevented.

130. Apparatus according to claim 127, wherein said first shaft is fixed to a steering wheel of said steering arrangement.

131. Apparatus according to claim 127, wherein said first shaft comprises a tubular end portion suitable for shapingly coupling with said second shaft.

132. Apparatus according to claim 131, wherein said first shaft is associated with said tubular end portion by means of a grooved surface.

133. Apparatus according to claim 127, wherein said first shaft is rotatably arranged inside a ring.

134. Apparatus according to claim 133, wherein said ring is so configured as to be capable of being translated together with said first shaft, when a driver of said vehicle moves said steering arrangement in a first direction.

135. Apparatus according to claim 134, wherein said ring is connected to actuating rod cooperating with a pump suitable for circulating a fluid inside a braking circuit.

136. Apparatus according to claim 135, wherein said actuating rod is slidably coupled with a stem.

137. Apparatus according to claim 136, wherein said stem comprises an abutting element arranged for enabling said actuating rod to move said stem only when said actuating rod moves in said first direction.

138. Apparatus according to claim 136, wherein a lever interacting with a piston of said pump is hinged on said stem.

139. Apparatus according to claim 127, wherein said first shaft is housed inside a hollow support intended for being arranged in a fixed position on said vehicle.

140. Apparatus according to claim 139, and further comprising an acceleration device actuatable by said first shaft when said first shaft interacts with said hollow support.

141. Apparatus according to claim 140, wherein said acceleration device comprises a position sensor arranged for detecting an axial position of said steering arrangement.

142. Apparatus according to claim 141, and further comprising a processing card arranged for actuating a valve suitable for intervening on a fuel entering an engine device of said go-cart, said processing card acting on said valve according to said axial position.

143. Apparatus according to claim 141, wherein said position sensor is selected from a group comprising: an encoder, a potentiometer.

144. Apparatus according to claim 140, wherein said position sensor is associated with a gear wheel actuatable by a rack connected with said first shaft.

145. Apparatus according to claim 144, and further comprising a microswitch element interacting with said rack in a preset reference position of said rack.

146. Apparatus according to claim 139, and further comprising a guide device arranged for keeping said first shaft guided in its movement in relation to said second shaft.

147. Apparatus according to claim 146, wherein said guide device comprises a guide wheel fixed to said hollow support and interacting with a guide bar associated with said first shaft.

148. Apparatus according to claim 127, wherein said second shaft can be coupled with a steering column through a joint.

149. Go-cart, comprising a steering arrangement, suitable for directing said go-cart along a given trajectory, and a speed control device, suitable for modifying the running speed of said go-cart, wherein said speed control device is so configured as to interact with said steering arrangement.

150. Go-cart according to claim 149, wherein said steering arrangement comprises a steering wheel and a steering column between which a joint member is placed that is suitable for enabling said steering wheel to be positioned according to a tilt that is substantially independent of said steering column.

151. Go-cart according to claim 149, wherein said speed control device comprises a braking device that can be actuated when said steering arrangement is moved in a first direction and an acceleration device that can be actuated when said steering arrangement is moved in a second direction opposite said first direction.

152. Go-cart according to claim 150, wherein said speed control device comprises a braking device that can be actuated when said steering arrangement is moved in a first direction and an acceleration device that can be actuated when said steering arrangement is moved in a second direction opposite said first direction.

153. Go-cart according to claim 152, wherein, when said steering wheel is displaced towards a driver it activates said acceleration device, and vice versa.

154. Go-cart according to claim 152, wherein said acceleration device comprises a cable actuatable through said steering arrangement and cooperating with a valve suitable for intervening on a fuel entering an engine device of said go-cart.

155. Go-cart according to claim 152, wherein said acceleration device comprises position sensor arranged for detecting an axial position of said steering arrangement.

156. Go-cart according to claim 155, and further comprising a processing card arranged for actuating a valve suitable for intervening on a fuel entering an engine device of said go-cart, said processing card acting on said valve according to said axial position.

157. Go-cart according to claim 155, wherein said position sensor is selected from a group comprising: an encoder, a potentiometer.

158. Go-cart according to claim 155, wherein said position sensor is associated with a gear arrangement that can be actuated by said steering arrangement.

159. Go-cart according to claim 152, wherein, when said steering wheel is moved away from a driver, said steering wheel activates said braking device, and vice versa.

160. Go-cart according to claim 152, wherein said braking device comprises an actuating rod cooperating with a pump suitable for circulates a fluid in a braking circuit.

161. Go-cart according to claim 160, wherein said actuating rod is slidably coupled with a stem.

162. Go-cart according to claim 161, wherein said stem comprises an abutting element arranged for enabling said actuating rod to move said stem only when said actuating rod moves in a preset direction.

163. Go-cart according to claim 161, wherein on said stem a lever is hinged, said lever interacting with a piston of said pump.

164. Go-cart according to claim 160, and further comprising a support structure for supporting said pump, said support structure being provided with a support plane suitable for receiving said pump resting on said support plane, in order to maintain said pump in a position that is substantially parallel to a surface on which said go-cart moves.

165. Go-cart according to claim 164, wherein said support structure comprises an anchor wall, to which said pump can be fixed.

166. Go-cart according to claim 164, wherein said support structure comprises a fixing element suitable for allowing said support structure to be fixed to a structural element of said go-cart.

167. Go-cart according to claim 166, wherein said fixing element comprises an arm provided with a clamp that can be fixed to said structural element.

168. Go-cart according to claim 163, wherein said support structure comprises at least one stiffening member suitable for increasing the bending and/or torsional stiffness of said support structure.

169. Go-cart according to claim 152, wherein said braking device and said acceleration device are connected with a movable member connected with said steering wheel.

170. Go-cart according to claim 169, wherein said movable member comprises a sleeve axially movable along a steering shaft.

171. Go-cart according to claim 169, wherein said speed control device further comprises a guide system arranged for guiding said movable member together with a shaft fixed to said steering wheel, at the same time preventing rotation between said movable member and said shaft.

172. Go-cart according to claim 171, wherein said guide system comprises a grooved surface placed between said movable member and said shaft.

173. Go-cart according to claim 171, wherein said guide system comprises an articulated quadrilateral arrangement that can be actuated by said steering arrangement.

174. Go-cart according to claim 173, wherein said articulated quadrilateral arrangement comprises an articulated parallelogram arrangement.

175. Go-cart according to claim 173, wherein said articulated quadrilateral arrangement comprises a first rocker arm and a second rocker arm arranged for connecting said movable member to a fixed member of said go-cart.

176. Go-cart according to claim 173, wherein said articulated quadrilateral arrangement comprises a first articulated quadrilateral arrangement and a second articulated quadrilateral arrangement arranged on opposite sides of said movable member.

177. Go-cart according to claim 173, wherein said shaft is connected by said joint member to a first end zone of said steering column.

178. Go-cart according to claim 177, wherein said steering column comprises a second end zone connected to a chassis of said go-cart by means of an articulated joint, said articulated joint being arranged for enabling said second end zone to move in relation to said chassis when said articulated quadrilateral arrangement actuates said shaft.

179. Go-cart according to claim 177, and further comprising further articulated joint placed between said steering column and a respective control device for controlling the steering of each wheel of said go-cart.

180. Go-cart according to claim 152, and further comprising manual actuating device arranged for actuating said acceleration device without translating said steering wheel.

181. Go-cart according to claim 180, wherein said manual actuating comprises a further lever mounted on said steering wheel.

182. Go-cart according to claim 150, and further comprising a quick connector arranged for enabling said steering wheel to be detached from, and attached to, a column member of said go-cart.

183. Go-cart according to claim 182, wherein said quick connector is provided with a protruding element suitable for shapingly coupling with a seat made in said column member.

184. Go-cart according to claim 182, wherein said steering wheel is provided with a tubular end suitable for receiving said column member, said tubular end being provided with a hole wherein said quick connector is inserted to lock said steering wheel on said column member.

185. Go-cart according to claim 149, and further comprising a hydraulic drive arrangement arranged for hydraulically modifying the position of wheels of said go-cart.

186. Go-cart according to claim 149, and further comprising a safety sensor arranged for detecting any obstacles near said go-cart and for preventing said go-cart from accelerating.

187. Go-cart provided with a steering arrangement comprising a steering column and a steering wheel by means of which a driver can set a trajectory for said go-cart, wherein between said steering wheel and said steering column a joint member is placed, said joint member being suitable for enabling said steering wheel to be positioned according to a tilt that is substantially independent of said steering column.

188. Go-cart according to claim 187, and further comprising a speed control device, suitable for modifying the running speed of said go-cart and so configured as to interact with said steering arrangement.

189. Go-cart according to claim 187, and further comprising a hydraulic drive arrangement arranged for hydraulically modifying the position of wheels of said go-cart.

190. Go-cart according to claim 187, and further comprising a safety sensor arranged for detecting any obstacles near said go-cart and for preventing said go-cart from accelerating.

191. Go-cart comprising a steering arrangement through which a driver can set a trajectory of said go-cart, said steering arrangement comprising a control device arranged for modifying the position of wheels of said go-cart according to a command from said driver, wherein said control device comprises a hydraulic drive arrangement arranged for hydraulically modifying said position.

192. Go-cart according to claim 191, wherein said hydraulic drive arrangement comprises a hydraulic drive box fed by a pressurised fluid through a pump.

193. Go-cart according to claim 192, wherein said pump is moved by means of a driving shaft of said go-cart.

194. Go-cart according to claim 192, wherein said hydraulic drive box is connected with a steering column of said go-cart by means of a joint.

195. Go-cart according to claim 192, and further comprising articulated-joint elements placed between said hydraulic drive box and a respective tie-rod arranged for steering wheels of said go-cart.

196. Go-cart according to claim 191, and further comprising a safety sensor arranged for detecting any obstacles near said go-cart and for preventing said go-cart from accelerating.

197. Apparatus for controlling the run of a vehicle, comprising a steering arrangement suitable for directing said vehicle along a given trajectory, and a speed control device suitable for modifying the running speed of said vehicle, wherein said speed control device comprises articulated quadrilateral arrangement actuatable by said steering arrangement.

198. Apparatus according to claim 197, wherein said articulated quadrilateral arrangement comprises articulated parallelogram arrangement.

199. Apparatus according to claim 197, wherein said articulated quadrilateral arrangement comprises a movable member connected to a fixed member through a first rocker arm and a second rocker arm, said movable member being associated with a shaft connected to a steering wheel of said steering arrangement.

200. Apparatus according to claim 199, wherein said articulated quadrilateral arrangement comprises a first articulated quadrilateral arrangement and a second articulated quadrilateral arrangement, arranged on opposite sides of said movable member.

201. Apparatus according to claim 199, wherein said shaft is coupled with said movable member in such a way as to enable the relative rotation and substantially prevent the relative translation.

202. Apparatus according to claim 199, and further comprising a steering column having a first end zone connected to say shaft through a joint member, and a second end zone connected to a chassis of said vehicle.

203. Apparatus according to claim 202, wherein between said second end zone and said chassis an articulated joint is provided, said articulated joint being arranged for enabling said second end zone to move in relation to said chassis when said articulated quadrilateral arrangement actuates said shaft.

204. Apparatus according to claim 202, and further comprising a further articulated joint placed between said steering column and a respective control device for controlling the steering of each wheel of said vehicle.

205. Apparatus according to claim 199, wherein to said movable member a braking device and an acceleration arrangement are connected, said braking device being actuatable when said steering arrangement is moved in a first direction and said acceleration device being actuatable when said steering arrangement is moved in a second direction opposite said first direction.

206. Apparatus according to claim 205, wherein said acceleration device comprises a cable actuatable by said movable member and cooperating with a valve suitable for intervening on a fuel entering an engine device of said vehicle.

207. Apparatus according to claim 205, wherein said acceleration device comprises a position sensor arranged for detecting the axial position of said shaft.

208. Apparatus according to claim 207, wherein said position sensor is selected from a group comprising: an encoder, a potentiometer.

209. Apparatus according to claim 207, wherein said position sensor is associated with a gear that can be actuated by said steering arrangement.

210. Apparatus according to claim 205, wherein said braking device comprises an actuating rod cooperating with a pump suitable for circulating a fluid inside a braking circuit.

211. Apparatus according to claim 210, wherein said actuating rod is slidably coupled with a stem.

212. Apparatus according to claim 211, wherein said stem comprises an abutting element arranged for enabling said actuating rod to move said stem only when said rod moves in a preset direction.

213. Apparatus according to claim 211, wherein a lever interacting with a piston of said pump is hinged on said stem.

214. Apparatus according to claim 210, and further comprising a support structure for supporting said pump, said support structure being provided with a support plane suitable for receiving said pump resting on said support plane to maintain said pump in a substantially horizontal position.

215. Apparatus according to claim 214, wherein said support structure comprises an arm provided with a clamp arranged for being fixed to a structural member of said vehicle.

216. Kit for a vehicle, comprising a braking control device suitable for actuating a braking device of said vehicle, and an acceleration control suitable for actuating an acceleration device of said vehicle, said braking control device and said acceleration control device being so configurable as to interact with a steering arrangement of said vehicle.

217. Kit according to claim 216, and further comprising a joint member, suitable for being placed between a steering column and a steering wheel of said a steering arrangement, in such a way as to enable said steering wheel to be positioned according to a tilt that is substantially independent of said steering column.

218. Kit according to claim 216, wherein said acceleration control device comprises a cable suitable for cooperating with a valve, in such a way as to intervene on fuel entering into an engine device of said vehicle.

219. Kit according to claim 216, wherein said acceleration control device comprises a position sensor arranged for detecting an axial position of said steering arrangement.

220. Kit according to claim 216, and further comprising a processing card arranged for actuating a valve suitable for intervening on a fuel entering an engine device of said vehicle, according to said axial position.

221. Kit according to claim 219, wherein said position sensor is selected from a group comprising: an encoder, a potentiometer.

222. Kit according to claim 219, and further comprising a gear arrangement associated with said position sensor and actuatable by said steering arrangement.

223. Kit according to claim 222, wherein said gear arrangement comprises a gear wheel associated with said position sensor and a rack fixed to said steering arrangement and arranged for actuating said gear wheel.

224. Kit according to claim 216, wherein said braking control device comprises an actuating rod cooperating with a pump suitable for supplying a fluid in a brake circuit of said vehicle.

225. Kit according to claim 224, wherein said braking control device comprises a stem suitable for being slidably coupled with said actuating rod.

226. Kit according to claim 225, wherein said stem comprises an abutting element arranged for enabling said actuating rod to move said stem only when said actuating rod moves in a first direction.

227. Kit according to claim 225, wherein said braking control device comprises a lever suitable for being hinged on said stem in such a way as to interact with a piston of said pump.

228. Kit according to claim 224, and further comprising a support structure suitable for supporting said pump.

229. Kit according to claim 228, wherein said support structure comprises a support plane for supporting said pump, said support plane being suitable for receiving said pump resting on said support plane to maintain said pump in a position that is substantially parallel to a surface on which said vehicle moves.

230. Kit according to claim 228, wherein said support structure comprises an anchor wall, to who said pump could be fixed.

231. Kit according to claim 228, wherein said support structure comprises a fixing element suitable for enabling said support structure to be fixed to a chassis of said vehicle.

232. Kit according to claim 231, wherein said fixing element comprises an arm provided with a clamp that can be fixed to say chassis.

233. Kit according to claim 228, wherein said support structure comprises at least one stiffening element suitable for increasing the bending and/or torsional stiffness of said support structure.

234. Kit according to claim 216, and further comprising an articulated quadrilateral arrangement arranged for actuating said braking control device and said acceleration control device by acting on said steering arrangement.

235. Kit according to claim 234, wherein said articulated quadrilateral arrangement comprises an articulated parallelogram arrangement.

236. Kit according to claim 234, wherein said articulated quadrilateral arrangement comprises a first rocker arm and a second rocker arm arranged for connecting to a fixed member of said vehicle a movable member that can be associated to said steering arrangement.

237. Kit according to claim 236, wherein said articulated quadrilateral arrangement comprises a first articulated quadrilateral arrangement and a second articulated quadrilateral arrangement arranged on opposite sides of said movable member.

238. Kit according to claim 217, and further comprising a shaft suitable for being placed between said joint member and said steering wheel.

239. Kit according to claim 238, and further comprising a sleeve axially movable along said shaft.

240. Kit according to claim 239, wherein said braking control device and said acceleration control device are connected with said sleeve.

241. Kit according to claim 239, and further comprising a sustaining element suitable for supporting said sleeve.

242. Kit according to claim 216, and further comprising a first shaft suitable for being slidably coupled with a second shaft of said vehicle to actuate said braking control device and said acceleration control device.

243. Kit according to claim 242, wherein said first shaft is so configured as to be telescopically coupled with said second shaft so that any relative rotation between said first shaft and said second shaft is substantially prevented.

244. Kit according to claim 243, wherein said first shaft is provided with a tubular end portion suitable for shapingly coupling with said second shaft.

245. Kit according to claim 242, and further comprising a ring within which said first shaft is rotatably arranged.

246. Kit according to claim 245, wherein said ring is so configured as to be capable of translating together with said first shaft, when a driver of said vehicle moves said steering arrangement in a first direction.

247. Apparatus for controlling the run of a vehicle, comprising a steering arrangement provided with a first steering column slidable in relation to a second steering column to modify the speed of said vehicle, and further comprising a position sensor suitable for detecting the axial position of said first steering column in relation to said second steering column.

248. Apparatus according to claim 247, wherein said position sensor comprises an encoder.
